(19) United States
(12) Patent Application Publication
(10) Pub. No.: US 2019/0204973 A1
(43) Pub. Date: Jul. 4, 2019

(54) TOUCH DISPLAY ASSEMBLY AND ELECTRONIC DEVICE

(71) Applicant: Lenovo (Beijing) Co., Ltd., Beijing (CN)

(72) Inventor: Shaopeng PENG, Beijing (CN)

(21) Appl. No.: 16/237,422

(22) Filed: Dec. 31, 2018

(30) Foreign Application Priority Data
Jan. 2, 2018 (CN) 201810003836.5

(51) Int. Cl. G06F 3/041; G06F 3/047; G06K 9/00; G06F 3/044

(52) U.S. Cl. CPC G06F 3/0412; G06F 3/047; G06K 9/0002; G06F 3/044; G06K 9/00053

(57) ABSTRACT

The touch display assembly includes a display, a touch sensing assembly, and a fingerprint collecting assembly. The display includes a screen and a display driving chip. The display driving chip is coupled to the screen through a plurality of data lines. The touch sensing assembly includes a touch sensing layer and a touch sensing chip. The touch sensing chip is coupled to the touch sensing layer through a plurality of touch sensing lines. The fingerprint collecting assembly includes a plurality of fingerprint collecting lines to collect a fingerprint. The plurality of fingerprint collecting lines partially overlap with the plurality of data lines.

### CROSS-REFERENCE TO RELATED APPLICATION

This application claims the priority of Chinese Patent Application No. 201810003836.5, filed on Jan. 2, 2018, the entire contents of which are incorporated herein by reference.

### TECHNICAL FIELD

The present disclosure relates to a touch display assembly and an electronic device.

### BACKGROUND

FIG. 1 illustrates a conventional solution of a front fingerprint sensor (FPS). The front fingerprint sensor needs to occupy a part of a screen, such that a display proportion of the screen becomes relatively small. To achieve a higher screen-to-body ratio, for example, to increase the display proportion of the screen of a terminal device, e.g., a mobile phone, one method is disposing a capacitive fingerprint sensor on the back side or on a side of the terminal device, while another method is disposing the fingerprint sensor, e.g., an optical or ultrasonic fingerprint recognition circuit, at the bottom of the screen. However, the former method may result in poor user experience, whereas technologies for the latter method are still immature and have problems such as a short device lifespan and high defect rate of the touch screen.

### SUMMARY

In accordance with the disclosure, one aspect of the present disclosure provides a touch display assembly. The touch display assembly includes a display, a touch sensing assembly, and a fingerprint collecting assembly. The display includes a screen and a display driving chip. The display driving chip is coupled to the screen through a plurality of data lines. The touch sensing assembly includes a touch sensing layer and a touch sensing chip. The touch sensing chip is coupled to the touch sensing layer through a plurality of touch sensing lines. The fingerprint collecting assembly includes a plurality of fingerprint collecting lines to collect a fingerprint. The plurality of fingerprint collecting lines partially overlap with the plurality of data lines.

In accordance with the disclosure, another aspect of the present disclosure provides an electronic device. The electronic device includes a touch display unit. The touch display unit includes a touch display assembly, a touch sensing assembly, and a fingerprint collecting assembly. The display assembly includes a display, a touch sensing assembly, and a plurality of fingerprint collecting lines. The display assembly is configured to display a content and includes a screen and a display driving chip. The display driving chip is coupled to the screen through a plurality of data lines. The touch sensing assembly is configured to sense a touch and includes a touch sensing layer and a touch sensing chip. The touch sensing chip is coupled to the touch sensing layer through a plurality of touch sensing lines. The fingerprint collecting assembly is configured to collect a fingerprint and includes a plurality of fingerprint collecting lines. The plurality of fingerprint collecting lines partially overlap with the plurality of data lines.

In accordance with the disclosure, another aspect of the present disclosure provides a fingerprint sensor. The fingerprint sensor includes a touch sensing layer and a touch sensing chip. The touch sensing layer includes a fingerprint collecting circuit. The fingerprint collecting circuit includes a plurality of fingerprint collecting lines. A fingerprint sensing circuit includes a portion of the plurality of fingerprint collecting lines. The plurality of the fingerprint collecting lines partially overlaps with a plurality of data lines of a display device. The touch sensing chip is coupled to the touch sensing layer and configured to drive the fingerprint collecting circuit to collect a fingerprint.

### DESCRIPTION OF THE DRAWINGS

To clearly understand the present disclosure and advantages thereof, the present disclosure is described below with reference to the accompany drawings, in which:

FIG. 1 schematically illustrates a conventional technical a front-fingerprint scheme;

FIG. 2A schematically illustrates a diagram of a front-fingerprint scheme according to an embodiment of the present disclosure;

FIG. 2B schematically illustrates a cross-sectional view of an area \textcircled{2} in FIG. 2A;

FIG. 2C schematically illustrates a wiring pattern of a Touch Film layer in FIG. 2B;

FIG. 2D schematically illustrates a wiring pattern of a 2nd Glass layer in FIG. 2B;

FIG. 3A schematically illustrates a front-fingerprint scheme in conventional technologies;

FIG. 3B schematically illustrates a cross-sectional view of an area \textcircled{2} in FIG. 3A;

FIG. 3C schematically illustrates a wiring pattern of a Touch Film layer in FIG. 3B;

FIG. 3D schematically illustrates a wiring pattern of a 2nd Glass layer in FIG. 3B;

FIG. 4 schematically illustrates a waveform diagram of time division multiplexing a portion of data lines of a fingerprint recognition and a data display according to an embodiment of the present disclosure.

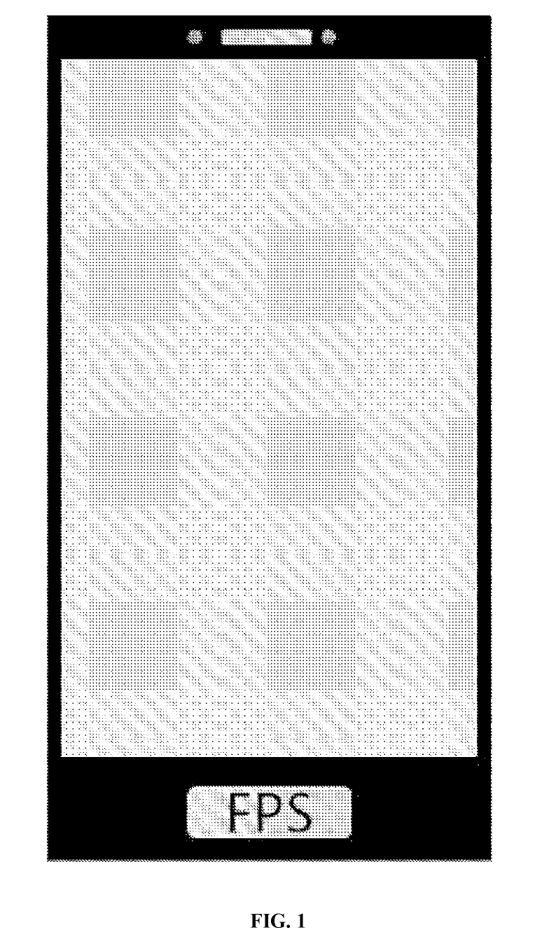

### DETAILED DESCRIPTION

Below describe embodiments of the present disclosure with reference to the accompanying drawings. It should be understood, however, that these descriptions are merely illustrative and are not intended to limit the scope of the present disclosure. In addition, in the following description, descriptions of well-known structures and techniques are omitted so as not to obscure the concept of the present disclosure.

Terms used herein are only for describing embodiments only but not intended to limit the present disclosure. The terms “including”, “comprising”, and the like, as used herein, indicate the presence of stated components, but do not exclude the presence or addition of one or more other components

Unless otherwise defined, all the technical and scientific terms used herein have the same or similar meanings as generally understood by those skilled in the art. It should be noted that terms used herein should be interpreted as having meanings that are consistent with the context of the present specification and should not be interpreted in an idealized or overly rigid manner.

In terms of a statement similar to “at least one of A, B, and C, etc.,” it should be generally interpreted in the light of the ordinary understanding of the expression by those skilled in the art (for example, “a system including at least one of A, B, and C” shall include, but is not limited to, a system including A alone, a system including B alone, a system including C alone, a system including A and B, a system including A and C, a system including B and C, and/or a system including A, B, and C, etc.). In terms of a statement similar to “at least one of A, B or C, etc.”, it should generally be interpreted in the light of the ordinary understanding of the expression by those skilled in the art (for example, “a system including at least one of A, B or C” shall include, but is not limited to, a system including A alone, a system including B alone, a system including C alone, a system including A and B, a system including A and C, a system including B and C, and/or a system including A, B, and C, etc.). It should also be understood by those skilled in the art that all transitional words and/or phrases representing two or more alternative items, whether in the description, the claims or the drawings, should be understood as including one of these alternative items, or including any one of or all these alternative items. For example, the phrase “A or B” should be interpreted to include possibilities of including “A” or “B”, or including “A” and “B”.

Embodiments of the present disclosure provide a touch display assembly, including a display, a touch sensor assembly, and a plurality of fingerprint collecting lines. The display may include a screen and a display driving chip. The display driving chip may be coupled to (e.g., connected to) the screen through a plurality of data lines. The touch sensor assembly may include a touch sensing layer, and a touch sensing chip. The touch sensing chip may be connected to the touch sensing layer through a plurality of touch sensing lines and the touch sensing layer may be disposed above the screen. The plurality of fingerprint collecting lines may partially overlap with the plurality of the data lines. The plurality of fingerprint collecting lines and the portion of the plurality of data lines partially overlapping with the plurality of fingerprint collecting lines may be configured to construct a fingerprint sensing circuit for collecting a fingerprint.

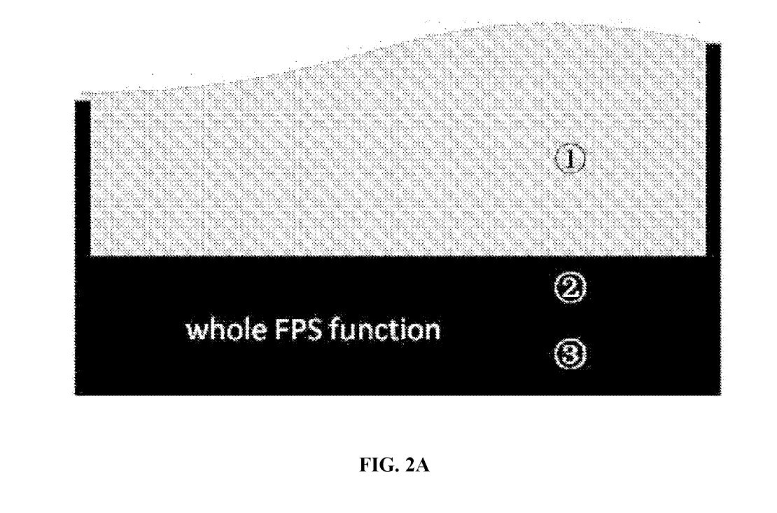

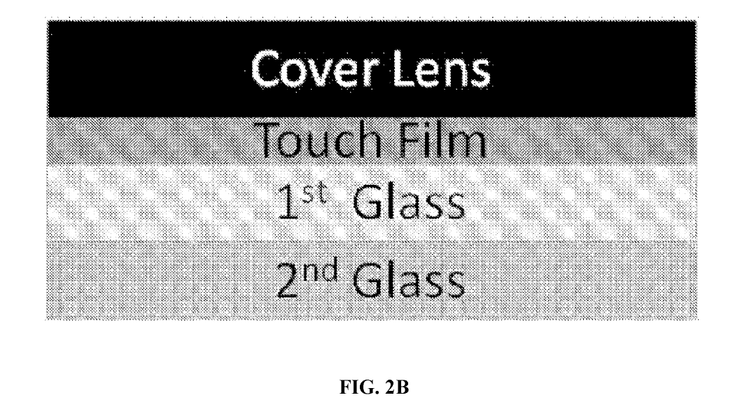

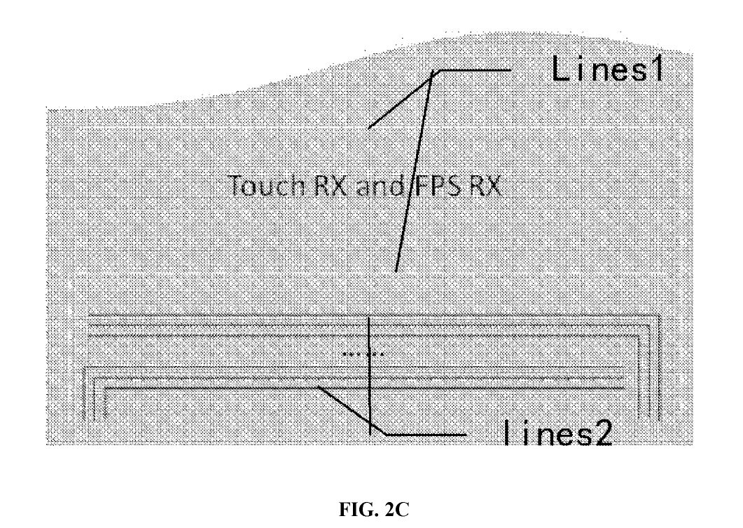

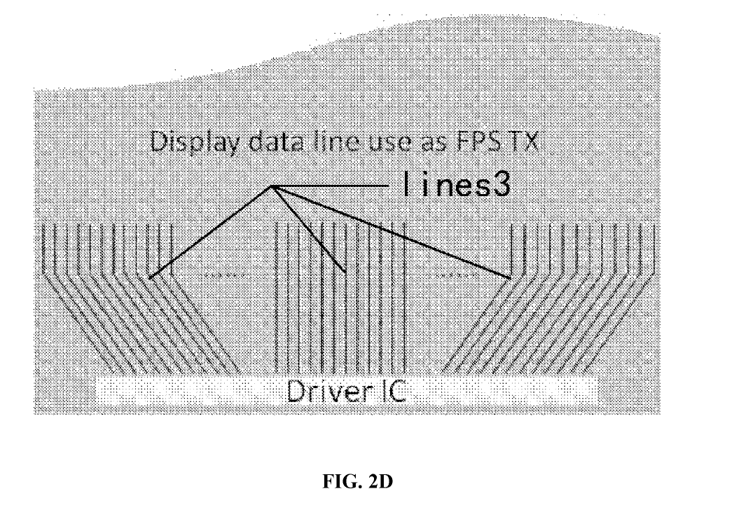

Below describes the present disclosure in detail with reference to FIGS. 2A-2D, FIGS. 3A-3D, and FIG. 4.

Embodiments of the present disclosure provide a touch display assembly, including a display, a touch sensor assembly, and a plurality of fingerprint collecting lines. The display may include a screen and a display driving chip. The display driving chip may be connected to the screen through a plurality of data lines. The touch sensor assembly may include a touch sensing layer, and a touch sensing chip. The touch sensing chip may be coupled to (e.g., connected to) the touch sensing layer through a plurality of touch sensing lines and the touch sensing layer may be disposed above the screen. The plurality of fingerprint collecting lines may partially overlap with the plurality of the data lines. The plurality of fingerprint collecting lines and the portion of the plurality of data lines partially overlapping with the plurality of the fingerprint collecting lines may be configured to construct a fingerprint sensing circuit for collecting a fingerprint.

The touch display assembly provided by embodiments of the present disclosure can be applied to various electronic devices, such as a smart phone, a tablet computer, and a smart watch, etc., which are not limited herein. A mobile phone is used as an example to describe the present disclosure in detail.

As shown in FIG. 2A, an area \textcircled{1} indicates that a display area of data contents of a mobile phone screen. Different from a conventional technology, an area \textcircled{2} and an area \textcircled{3} indicate one area, which is equivalent to an area by combining a fingerprint recognition area of a screen and a lower frame of the display touch assembly.

As shown in FIG. 2B, it can be seen from a cross-sectional view of the area \textcircled{2} that each touch display assembly in the area \textcircled{2} may generally include multiple layers, which are from top to bottom, a cover layer (Cover Lens), a touch layer (Touch Film), a first glass layer (1st Glass), and a second glass layer (2nd Glass). It should be noted that the display described above may correspond to the second glass layer (i.e., a touch display unit and the data lines corresponding to the touch display unit may be disposed on an inner surface of the second glass layer to realize the display), and the touch sensing assembly may correspond to the touch layer. Optionally, in some embodiments of the present disclosure, there may be no first glass layer (1st Glass) and/or no cover layer (Cover Lens).

Based on above, as shown in FIG. 2C, in the touch layer of the area \textcircled{2}, the plurality of touch sensing lines may be arranged in a lines1 pattern, and the plurality of fingerprint collecting lines may be arranged in a lines2 pattern. The plurality of fingerprint collecting lines may partially overlap with the plurality of the data lines. The plurality of fingerprint collecting lines and the portion of the plurality of data lines partially overlapping with the plurality of the fingerprint collecting lines may be configured to form a fingerprint sensing circuit for collecting a fingerprint.

According to embodiments of the present disclosure, the plurality of fingerprint collecting lines may partially overlap with the plurality of the data lines. The plurality of fingerprint collecting lines and the portion of the plurality of data lines partially overlapping with the plurality of the fingerprint collecting lines may be configured to form the fingerprint sensing circuit for collecting the fingerprint. In this way, overall there is no need to leave a separate area for fingerprint recognition, and the proportion of the data display area in the entire touch display unit can be increased.

The fingerprint chip in the present disclosure may be a capacitive fingerprint system (FPS). According to the present disclosure, based on a conventional display, the capacitive FPS may be integrated into a full screen. In this way, a user can still unlock from the front, and in addition, the screen-to-body ratio can be increased, optimizing the user experience and increasing the area for fingerprint unlocking.

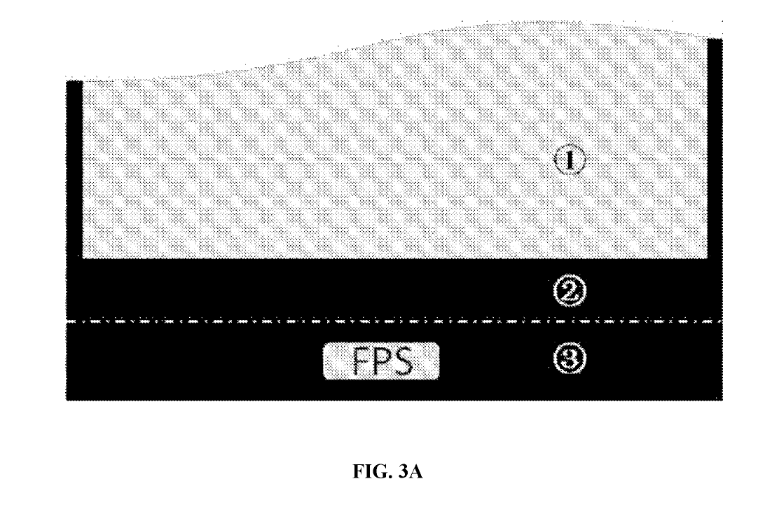

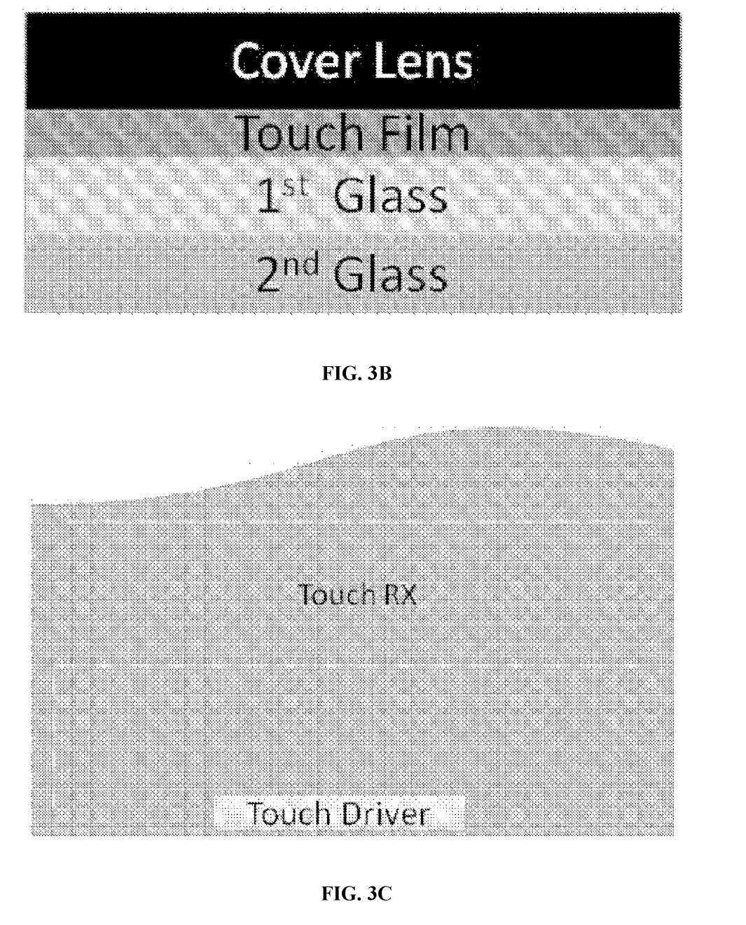

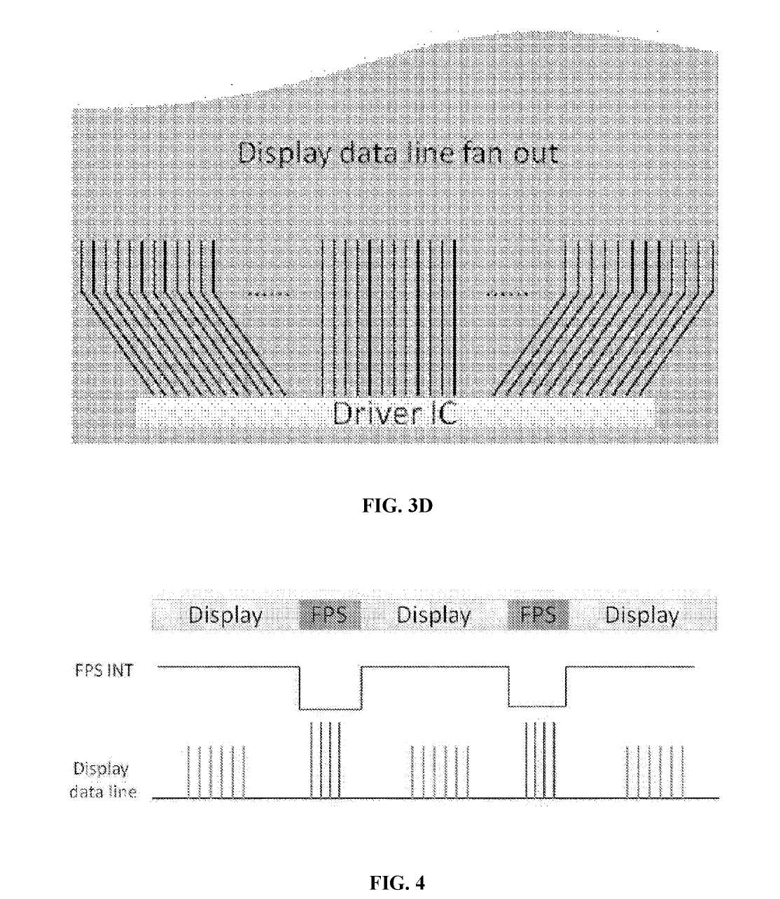

In the conventional technology, as shown in FIG. 3A, the area \textcircled{1} indicates an area for displaying the data content. The area \textcircled{2} and the area \textcircled{3} may be two different areas. The area \textcircled{3} may be the fingerprint recognition area of the mobile phone screen, while the area \textcircled{2} may be the lower frame of the touch display assembly.

As shown in FIG. 3B, it can be seen from a cross-sectional view of the area \textcircled{2}, similar to the present disclosure, that each touch display assembly in the area \textcircled{2} may generally include multiple layers, which are from top to bottom, a cover layer (Cover Lens), a touch layer (Touch Film), a first glass layer (1st Glass), and a second glass layer (2nd Glass).

Different from the present disclosure, in the conventional technologies, it is seen from the sectional view of the area \textcircled{2} shown in FIG. 3C, that there is only the plurality of touch sensing lines arranged as lines1 pattern in the area \textcircled{2}; however, the plurality of fingerprint collecting lines are not disposed in the touch layer that the area \textcircled{2} corresponds to, but in the touch layer (not shown) that the area \textcircled{3} corresponds to. As shown in FIG. 3D, the plurality of data lines in the second glass layer may also be arranged as lines3 pattern, which is similar as the present disclosure. However, in the conventional technologies, the plurality of data lines are disposed in the second glass layer that the area \textcircled{2} corresponds to, while the plurality of fingerprint collecting lines are disposed in the touch layer that the area \textcircled{3} corresponds to. Therefore, in conventional technologies, the plurality of fingerprint collecting lines cannot overlap with the plurality of the data lines. Such that the plurality of fingerprint collecting lines and the plurality of data lines cannot form the fingerprint sensing circuit for collecting fingerprints.

It should be noted that, according to embodiments of the present disclosure, as shown by a cross-sectional view of the area \textcircled{2} in FIG. 2B, the fingerprint collecting lines and circuits at the lower frame of the touch display assembly may be covered by the black ink (BM) of the cover lens.

Optionally, the touch display assembly may further include: a fingerprint chip, where the plurality of fingerprint collecting lines are connected to the fingerprint chip, and the fingerprint chip is connected to the display driving chip and configured to occupy a first group of data lines of the plurality of data lines. The first group of data line are data lines of the plurality of data lines that overlaps with the plurality of fingerprint collecting lines.

As shown in FIG. 2A, the area \textcircled{1} is the data display area, and the area \textcircled{2} and the area \textcircled{3} are combined into one area, which is the lower frame of the touch display assembly. According to embodiments of the present disclosure, the capacitive FPS may be disposed in the combined areas \textcircled{2} and \textcircled{3}. The layer stacking shown in FIG. 2B is the same as the conventional technologies. Below the area \textcircled{2} and the area \textcircled{3} shown in FIG. 2A, more data lines may be added into the touch film layer, for example, lines2 shown in FIG. 2A, and configured to be a receiver (RX) of the capacitive FPS. A line-to-line distance of the RX of the FPS is smaller than a line-to-line distance of a touch RX, i.e., the plurality of the touch sensing lines. For example, the line-to-line distance of the touch RX may be approximately 4 mm, and a line-to-line distance of the plurality of data lines may be approximately 2 μm. Embodiments of the present disclosure do not limit the value of the line-to-line distance. The display data line shown in FIG. 2D may be configured to be the transmitter (TX) of the capacitive FPS, such that the TX and the RX of the capacitive FPS can be interlaced and fill the entire area of the area \textcircled{2} and the area \textcircled{3}. To enlarge the fingerprint functional area, there can be more lines for TX of the FPS or the display data line can be elongated to increase the overlapping area of the two thereof. Another advantage may be that the lower frame of the whole terminal device can be reduced, thereby increasing the screen-to-body ratio.

Optionally, the plurality of fingerprint collecting lines and the plurality of touch sensing lines of the touch sensing assembly may be located in a same plane.

That is, the plurality of fingerprint collecting lines and the plurality of touch sensing lines of the touch sensing assembly may be located in a plane in which the touch layer is located as shown in FIG. 2B.

Optionally, the line-to-line distance of the plurality of fingerprint collecting lines may be smaller than the line-to-line distance of the plurality of touch sensing lines.

FIG. 2C shows the layer on the Touch Film. The line-to-line distance of the touch RX is generally about 4 mm, as shown in FIG. 2D, while the line-to-line distance of the display data line is about 2 Lines extending from a driver integrated circuit (IC) may be disposed below the area \textcircled{2} in FIG. 2A. The display data lines are dense, because of which, according to embodiments of the present disclosure, the capacitive FPS can be integrated into the screen.

Optionally, when the fingerprint chip is in an operative state, the plurality of fingerprint collecting lines may be configured to be a RX of the fingerprint chip. The first group of data lines may be configured to be a TX of the fingerprint chip. The first group of data lines may be time-division used by the fingerprint chip and the display driving chip when the fingerprint is in the operative state. The first of the data lines may only be used by the display driving chip when the fingerprint chip is not in the operative state.

FIG. 4 shows an example of a driver, multiplexed the display data lines by a time-division multiplexing (TDM) method. When signal is interrupt by fingerprint recognition, the display data lines may be used for the capacitive fingerprint recognition, and used for displaying data for the rest of time.

The present disclosure also provides an electronic device including a touch display unit, which includes a first area and a second area. The touch display unit may be composed of a touch display assembly, which includes a display, a touch sensor assembly, and a plurality of fingerprint collecting lines. The display may include a screen and a display driving chip. The display driving chip may be connected to the screen through a plurality of data lines. The touch sensor assembly may include a touch sensing layer, and a touch sensing chip. The touch sensing chip may be connected to the touch sensing layer through a plurality of touch sensing lines and the touch sensing layer may be disposed above the screen. The plurality of fingerprint collecting lines may partially overlap with the plurality of the data lines. The plurality of wire lines and the portion of the plurality of data lines partially overlapping with the plurality of fingerprint collecting lines may be configured to construct a fingerprint sensing circuit for collecting the fingerprint. The first area may include a data display area, and the second area may include a fingerprint recognition area. The second area may correspond to the portion where the plurality of fingerprint collecting lines partially overlap with the plurality of data lines.

As shown in FIG. 2A, an area \textcircled{1} indicates that a display area of data contents of a mobile phone screen. An area \textcircled{2} and an area \textcircled{3} indicate one area, which is equivalent to combining a fingerprint recognition area of a conventional mobile phone screen and a lower frame of the display touch assembly into one.

As shown in FIG. 2B, it can be seen from a cross-sectional view of the area \textcircled{2} that each touch display assembly in the area \textcircled{2} may generally include multiple layers, which are from top to bottom, a cover layer (Cover Lens), a touch layer (Touch Film), a first glass layer (1st Glass), and a second glass layer (2nd Glass). It should be noted that the display described above may correspond to the second glass layer (i.e., a touch display unit and the data lines corresponding to the touch display unit may be disposed on an inner surface of the second glass layer to realize the display), and the touch sensing assembly may correspond to the touch layer. Optionally, in some embodiments of the present disclosure, there may be no first glass layer (1st Glass) and/or no cover layer (Cover Lens).

Based on above, as shown in FIG. 2C, in the touch layer corresponding to the area \textcircled{2}, the plurality of touch sensing lines may be arranged in a lines1 pattern, and the plurality of fingerprint collecting lines may be arranged in a lines2 pattern. The plurality of fingerprint collecting lines may partially overlap with the plurality of the data lines. The plurality of fingerprint collecting lines and the portion of the plurality of data lines partially overlapping with the plurality of fingerprint collecting lines may be configured to construct a fingerprint sensing circuit for collecting a fingerprint.

According to embodiments of the present disclosure, the plurality of fingerprint collecting lines may partially overlap with the plurality of the data lines. The plurality of fingerprint collecting lines and the portion of the plurality of data lines partially overlapping with the plurality of fingerprint collecting lines may be configured to construct a fingerprint sensing circuit for collecting the fingerprint. In this way, overall there is no need to leave a separate area for fingerprint recognition, and the technical effect of increasing the proportion of the data display area in the entire touch display unit can be achieved.

It should be noted that the fingerprint chip in the present disclosure may be a capacitive FPS. According to the present disclosure, based on an conventional display, the capacitive FPS may be integrated into a full screen. In this way, a user can still unlock from the front, and in addition, the screen-to-body ratio can be increased, optimizing the user experience and increasing the area for fingerprint unlocking.

Optionally, the touch display assembly may further include: a fingerprint chip, where the plurality of fingerprint collecting lines are connected to the fingerprint chip, and the fingerprint chip is connected to the display driving chip and configured to occupy a first group of data lines of the plurality of data lines, so as to increase a ratio of the first area to the entire touch display unit. The first group of data lines are data lines of the plurality of data lines that overlap with the plurality of fingerprint collecting lines.

Optionally, the plurality of fingerprint collecting lines and the plurality of touch sensing lines of the touch sensing assembly may be located in a same plane.

Optionally, the line-to-line distance of the plurality of fingerprint collecting lines may be smaller than the line-to-line distance of the plurality of touch sensing lines.

Optionally, when the fingerprint chip is in an operative state, the plurality of fingerprint collecting lines may be configured to be a RX of the fingerprint chip. The first group of data lines may be configured to be a TX of the fingerprint chip. The first group of data lines may be time-division used by the fingerprint chip and the display driving chip when the fingerprint is in the operative state. The first of the data lines may only be used by the display driving chip when the fingerprint chip is not in the operative state. When only the fingerprint recognition is performed by the electronic device, the fingerprint chip can transmit a driving signal through the TX and receive a feedback signal from the RX. The feedback signal may be used by the fingerprint chip for fingerprint recognition. When there is certain content displayed by the screen while the electronic device is performing the fingerprint recognition, the first group of data lines may be time-division used by the driving signal transmitted by the fingerprint chip and a display signal output by the display driving chip. The fingerprint chip can receive the feedback signal through the RX, and the feedback signal can be used by the fingerprint chip for fingerprint recognition. Therefore, the fingerprint recognition can still be realized when there is certain content displayed by the screen.

According to embodiments of the present disclosure, a data line of the display may be used as the TX of the fingerprint, and a plurality of fingerprint collecting lines added in the touch area may be used as the RX of the fingerprint. The plurality of fingerprint collecting lines used as the RX can overlap with the data lines used as the TX, and as observed from as certain direction, the plurality of fingerprint collecting lines used as the RX can be interlaced with the data lines used as the TX.

Those skilled in the art should understand that the features described in embodiments and/or claims of the present disclosure can be combined in various manners, even though such combinations are not explicitly described in the present disclosure. In particular, various combinations of features described in various embodiments and/or claims of the present disclosure may be made without departing from the spirit and teaching of the present disclosure. All these combinations shall fall within the scope of the present disclosure.

Although the present disclosure has been shown and described with reference to specific exemplary embodiments thereof, it will be understood by those skilled in the art that without departing from the spirit and scope of the present disclosure defined by the appended claims and their equivalents, various modifications in form and detail may be made to the present disclosure. Therefore, the scope of the present disclosure should not be limited to the above-described embodiments but should be determined not only by the appended claims but also by the equivalents of the appended claims.

What is claimed is:

1. A touch display assembly, comprising:
a display including a screen and a display driving chip, wherein the display driving chip is coupled to the screen through a plurality of data lines;
a touch sensing assembly, including a touch sensing layer and a touch sensing chip coupled to the touch sensing layer through a plurality of touch sensing lines; and
a fingerprint collecting assembly, including a plurality of fingerprint collecting lines to collect a fingerprint, wherein the plurality of fingerprint collecting lines partially overlap with the plurality of data lines.

2. The touch display assembly according to claim 1, further comprising a fingerprint chip, wherein:
the plurality of fingerprint collecting lines are coupled to the fingerprint chip;
the fingerprint chip is coupled to the display driving chip and connects to a first group of data lines of the plurality of data lines; and
the first group of the data lines are data lines that overlap with the plurality of fingerprint collecting lines.

3. The touch display assembly according to claim 2, wherein:
in response to the fingerprint chip being in an operative state, the plurality of fingerprint collecting lines act as a receiver of the fingerprint chip, and the first group of data lines act as a transmitter of the fingerprint chip;
the first group of data lines are time-division used by the fingerprint chip and the display driving chip when the fingerprint chip is in the operative state; and
the first group of data lines are used by the display driving chip when the fingerprint chip is not in the operative state.

4. The touch display assembly according to claim 1, wherein:
the plurality of fingerprint collecting lines are in a same plane as the plurality of touch sensing lines of the touch sensing assembly.

5. The touch display assembly according to claim 4 wherein:
a line-to-line distance of the plurality of fingerprint collecting lines is less than a line-to-line distance of the plurality of touch sensing lines.

6. An electronic device comprising:
a touch display unit, comprising:
a display assembly configured to display a content, the display assembly including a screen and a display driving chip, wherein the display driving chip is coupled to the screen through a plurality of data lines;
a touch sensing assembly configured to sense a touch, the touch sensing assembly including a touch sensing layer and a touch sensing chip, wherein the touch sensing chip is coupled to the touch sensing layer through a plurality of touch sensing lines; and
a fingerprint collecting assembly configured to collect a fingerprint, the fingerprint collecting assembly including a plurality of fingerprint collecting lines, wherein: the plurality of fingerprint collecting lines of the fingerprint collecting assembly partially overlap with the plurality of data lines of the display assembly.

7. The electronic device according to claim 6, wherein the touch display assembly further comprises:
the plurality of fingerprint collecting lines being coupled to the fingerprint chip;
the fingerprint chip being coupled to the display driving chip, and is configured to occupy a first group of data lines of the plurality of data lines; and
the first group of data lines being data lines that overlap with the plurality of fingerprint collecting lines.

8. The electronic device according to claim 7, wherein:
in response to the fingerprint chip being in an operative state, the plurality of fingerprint collecting lines act as a receiver of the fingerprint chip, and the first group of data lines act as a transmitter of the fingerprint chip;
the first group of data lines are time-division used by the fingerprint chip and the display driving chip when the fingerprint chip is in the operative state;
the first group of data lines is used by the display driving chip when the fingerprint chip is not in the operative state;
in response to the electronic device being only performing fingerprint recognition, the fingerprint chip transmits a driving signal through the transmitter and receives a feedback signal from the receiver, and detects a fingerprint based on the feedback signal; and
in response to content being displayed by the screen while the electronic device is performing the fingerprint recognition, the first group of data lines are time-division used by the driving signal transmitted by the fingerprint chip and a display signal outputted by the display driving chip; the fingerprint chip receives the feedback signal through the receiver, and detects a fingerprint based on the feedback signal.

9. The electronic device according to claim 6 wherein:
the plurality of fingerprint collecting lines are in a same plane as the plurality of touch sensing lines of the touch sensing assembly.

10. The electronic device according to claim 9, wherein:
a line-to-line distance of the plurality of fingerprint collecting lines is smaller than a line-to-line distance of the plurality of touch sensing lines.

11. A fingerprint sensor, comprising:
a touch sensing layer including a fingerprint collecting circuit, which comprises a plurality of fingerprint collecting lines overlapping with a plurality of data lines of a display device; and
a touch sensing chip coupled to the touch sensing layer, the touch sensing chip being configured to drive the fingerprint collecting circuit to collect a fingerprint.

12. The fingerprint sensor according to claim 11, further comprising a fingerprint chip coupled to the plurality of fingerprint collecting lines and the portion of the plurality of data lines.

13. The fingerprint senor according to claim 12, wherein the fingerprint sensor is coupled to a display through the plurality of data lines.

14. The fingerprint senor according to claim 13, wherein:
in response to the fingerprint chip being in an operative state, the plurality of fingerprint collecting lines act as a receiver of the fingerprint chip, and the portion of the plurality of data lines act as a transmitter of the fingerprint chip;
the portion of the plurality of data lines is time-division used by the fingerprint chip and the display when the fingerprint chip is in the operative state; and
the portion of the plurality of data lines is used by the display when the fingerprint chip is not in the operative state.

15. The fingerprint sensor according to claim 11, wherein the plurality of fingerprint collecting lines are in a same plane as the plurality of touch sensing lines.

16. The fingerprint sensor according to claim 15, wherein a line-to-line distance of the plurality of fingerprint collecting lines is less than a line-to-line distance of the plurality of touch sensing lines.
